(19) United States
(12) Patent Application Publication
(10) Pub. No.: US 2025/0389989 A1
(43) Pub. Date: Dec. 25, 2025

(54) INTELLIGENT REFLECTING SURFACE

(71) Applicant: Japan Display Inc., Tokyo (JP)

(72) Inventors: Shinichiro OKA, Tokyo (JP); Mitsutaka OKITA, Tokyo (JP); Daiichi SUZUKI, Tokyo (JP)

(73) Assignee: Japan Display Inc., Tokyo (JP)

(21) Appl. No.: 19/305,809

(22) Filed: Aug. 21, 2025

Related U.S. Application Data
(63) Continuation of application No. PCT/JP2023/045954, filed on Dec. 21, 2023.

(30) Foreign Application Priority Data
Feb. 27, 2023 (JP) 2023-028421

(51) Int. Cl. G02F 1/1337

(52) U.S. Cl. CPC G02F 1/133757; G02F 2203/02

(57) ABSTRACT

An intelligent reflecting surface invention includes a first substrate, a plurality of patch electrodes on the first substrate, a first alignment film covering the plurality of patch electrodes, a second substrate, a plurality of ground electrodes on the second substrate, a second alignment film covering the plurality of ground electrodes, and a liquid crystal layer including liquid crystal molecules with a twist alignment between the first alignment film and the second alignment film. A distance (d) between the first substrate and the second substrate is greater than or equal to 10 μm. A chiral pitch (p) of the liquid crystal layer and the distance (d) satisfy a relational equation d≤p<4d/3.

### CROSS-REFERENCE TO RELATED APPLICATIONS

This application is a Continuation of International Patent Application No. PCT/JP2023/045954, filed on Dec. 21, 2023, which claims the benefit of priority to Japanese Patent Application No. 2023-028421, filed on Feb. 27, 2023, the entire contents of each are incorporated herein by reference.

### FIELD

An embodiment of the present invention relates to an intelligent reflecting surface capable of controlling a reflection direction of an incident radio wave.

### BACKGROUND

A phased array antenna device has a plurality of antenna elements arranged in a plane, and controls the directionality of a radio wave by adjusting the amplitude and phase of a high-frequency signal applied to each of the plurality of antenna elements while the phased array antenna device is fixed. The phased array antenna device requires a phase shifter. The phased array antenna device including a phase shifter that uses a change in dielectric constant due to the alignment state of a liquid crystal is disclosed (for example, see Japanese laid-open patent application No. H11-103201).

The antenna element of the phased array antenna device in Japanese laid-open patent application No. H11-103201 has a plurality of strip wirings, a planar electrode facing the plurality of strip wirings, and a liquid crystal layer between the plurality of strip wirings and the planar electrode. Different voltages are applied to the plurality of strip wirings in the plurality of antenna elements. The phase can be changed by adjusting the dielectric constant of the liquid crystal layer for each antenna element and superposing the reflected waves. In this way, the reflecting direction of the radio wave can be set in any direction.

### SUMMARY

An intelligent reflecting surface according to an embodiment of the present invention includes a first substrate, a plurality of patch electrodes on the first substrate, a first alignment film covering the plurality of patch electrodes, a second substrate, a plurality of ground electrodes on the second substrate, a second alignment film covering the plurality of ground electrodes, and a liquid crystal layer including liquid crystal molecules with a twist alignment between the first alignment film and the second alignment film. A distance (d) between the first substrate and the second substrate is greater than or equal to 10 μm. A chiral pitch (p) of the liquid crystal layer and the distance (d) satisfy a relational equation d≤p<4d/3.

An intelligent reflecting surface according to an embodiment of the present invention includes a first substrate, a plurality of patch electrodes on the first substrate, a first alignment film covering the plurality of patch electrodes, a second substrate, a plurality of ground electrodes on the second substrate, a second alignment film covering the plurality of ground electrodes, and a liquid crystal layer between the first alignment film and the second alignment film. The liquid crystal layer includes liquid crystal molecules with a twist alignment. A distance (d) between the first substrate and the second substrate is greater than or equal to 10 μm. A chiral pitch (p) of the liquid crystal layer and the distance (d) satisfy a relational equation d<p<2d.

### BRIEF DESCRIPTION OF DRAWINGS

FIG. 1 is a schematic plan diagram showing an outline of a configuration of an intelligent reflecting surface according to an embodiment of the present invention.

FIG. 2A is a schematic plan diagram showing a configuration of a reflecting antenna cell of an intelligent reflecting surface according to an embodiment of the present invention.

FIG. 2B is a schematic cross-sectional diagram showing a configuration of a reflecting antenna cell of an intelligent reflecting surface according to an embodiment of the present invention.

FIG. 3 is a schematic diagram showing a reflection direction of a radio wave due to a reflecting antenna cell of an intelligent reflecting surface according to an embodiment of the present invention.

FIG. 4A is a schematic cross-sectional diagram showing a configuration of a liquid crystal layer in a reflecting antenna cell of an intelligent reflecting surface according to an embodiment of the present invention.

FIG. 4B is a schematic cross-sectional diagram showing a configuration of a liquid crystal layer in a reflecting antenna cell of an intelligent reflecting surface according to an embodiment of the present invention.

FIG. 4C is a schematic cross-sectional diagram showing a configuration of a liquid crystal layer in a reflecting antenna cell of an intelligent reflecting surface according to an embodiment of the present invention.

FIG. 4D is a schematic cross-sectional diagram showing a configuration of a liquid crystal layer in a reflecting antenna cell of an intelligent reflecting surface according to an embodiment of the present invention.

FIG. 5 is a graph showing a correlation between a twist angle and response time of a liquid crystal in a liquid crystal layer in an intelligent reflecting surface according to an embodiment of the present invention.

### DESCRIPTION OF EMBODIMENTS

Liquid crystal molecules contained in a liquid crystal layer of a conventional intelligent reflecting surface have a homogeneous orientation in an initial state (when no voltage is applied). However, there is a problem in that a response speed of the liquid crystal is slow so that the intelligent reflecting surface has the liquid crystal layer thicker than a display such as an LCD.

In view of the above problem, an embodiment of the present invention can provide an intelligent reflecting surface including a liquid crystal with high response speed.

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by a, b, etc.) and a detailed description may be omitted as appropriate. The terms “first” and “second” appended to each component are a convenience sign used to distinguish them and have no further meaning except as otherwise explained.

As used in the present specification, where a member or region is “on” (or “under”) another member or region, this includes cases where it is not only directly on (or just under) the other member or region but also above (or below) the other member or region, unless otherwise specified. That is, it includes the case where another component is included in between above (or below) other members or regions.

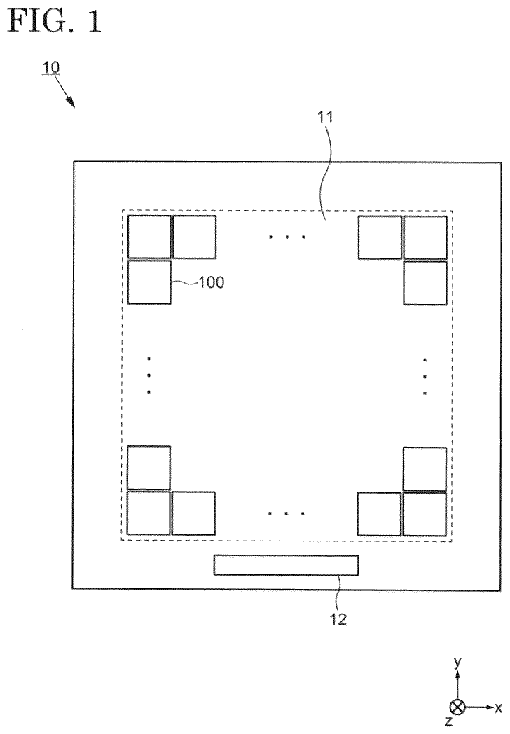

An intelligent reflecting surface 10 according to an embodiment of the present invention is described with reference to FIGS. 1 to 5.

### 1. Configuration of Intelligent Reflecting Surface 10

FIG. 1 is a schematic plan view showing an outline of a configuration of the intelligent reflecting surface 10 according to an embodiment of the present invention.

As shown in FIG. 1, the intelligent reflecting surface 10 includes a reflecting antenna region 11 and a driving circuit region 12. The reflecting antenna region 11 is provided in the center of the intelligent reflecting surface 10, and the driving circuit region 12 is provided in the peripheral region of the intelligent reflecting surface 10. In other words, the driving circuit region 12 is provided around the reflecting antenna region 11. A plurality of reflecting antenna cells 100 are provided in the reflecting antenna region 11. A driving circuit that generates a control signal to control each of the plurality of reflecting antenna cells 100 is provided in the driving circuit region 12.

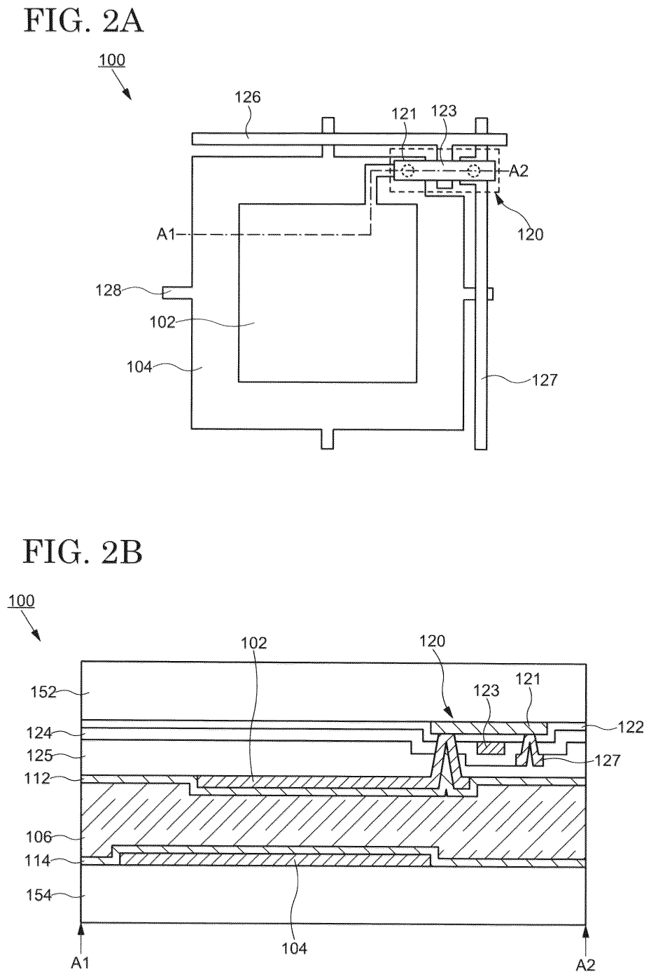

In the reflecting antenna region 11, the reflecting antenna cells 100 are arranged in a matrix along an x-axis direction and a y-axis direction. However, the arrangement of the reflecting antenna cells 100 is not limited thereto. Here, a configuration of the reflecting antenna cell 100 is described with reference to FIGS. 2A and 2B.

FIG. 2A is a schematic plan view showing a configuration of the reflecting antenna cell 100 of the intelligent reflecting surface 10 according to an embodiment of the present invention. FIG. 2B is a schematic cross-sectional view showing a configuration of the reflecting antenna cell 100 of the intelligent reflecting surface 10 according to an embodiment of the present invention. Specifically, FIG. 2B is a cross-sectional view of the reflecting antenna cell 100 cut along the line A1-A2 in FIG. 2A. In addition, a part of the configuration of the reflecting antenna cell 100 is omitted in FIG. 2A, for convenience.

As shown in FIGS. 2A and 2B, the reflecting antenna cell 100 includes a patch electrode 102 provided on a first substrate 152 and a ground electrode 104 provided on a second substrate 154. The first substrate 152 and the second substrate 154 are arranged so that the patch electrode 102 and the ground electrode 104 face each other. A first alignment film 112 and a second alignment film 114 are provided on the patch electrode 102 and the ground electrode 104, respectively. Further, a liquid crystal layer 106 is provided between the first alignment film 112 and the second alignment film 114. That is, the initial alignment (alignment when no voltage is applied) of the liquid crystal molecules in the liquid crystal layer 106 is controlled by the first alignment film 112 and the second alignment film 114. In the intelligent reflecting surface 10, the alignment state of the liquid crystal molecules in the liquid crystal layer 106 can be changed by the voltage applied to the patch electrode 102.

Hereinafter, a description is provided whereby a radio wave (an incident wave) is incident from the first substrate 152 side.

In a plan view, the area of the patch electrode 102 is smaller than the area of the ground electrode 104. Although the shape of each of the patch electrode 102 and the ground electrode 104 is a square, the shape is not limited thereto. The shape of each of the patch electrode 102 and the ground electrode 104 may be, for example, a rectangle or another geometric shape.

The patch electrode 102 is electrically connected to a switching element 120. The switching element 120 includes a semiconductor layer 121, a gate insulating layer 122, and a gate electrode 123. Although the switching element 120 shown in FIGS. 2A and 2B is a so-called transistor, the configuration of the switching element 120 is not limited thereto. The switching element 120 is provided on the first substrate 152. The semiconductor layer 121 is provided on the first substrate 152. The gate electrode 123 is provided so as to overlap the semiconductor layer 121. The gate electrode 123 is electrically connected to a selection signal line 126. The gate insulating layer 122 is provided between the semiconductor layer 121 and the gate electrode 123. Further, an interlayer insulating layer 124 is provided over the gate electrode 123. Two openings are formed in the interlayer insulating layer 124 to expose the semiconductor layer 121. The semiconductor layer 121 is electrically connected to the patch electrode 102 through one opening, and is electrically connected to a data signal line 127 through the other opening. A planarizing layer 125 is provided over the interlayer insulating layer 124 and the data signal line 127. The patch electrode 102 is provided on the planarizing layer 125.

The selection signal line 126 and the data signal line 127 are electrically connected to a drive circuit in the drive circuit region 12. A control signal from the drive circuit is input to the switching element 120 through the selection signal line 126 and the data signal line 127. The switching element 120 operates based on the control signal, thereby changing the alignment state of the liquid crystal molecules in the liquid crystal layer 106.

The ground electrode 104 is electrically connected to a ground wiring 128. The ground electrode 104 and the ground wiring 128 may be formed of the same conductive layer. The ground wiring 128 electrically connects adjacent ground electrodes 104 to each other. The ground electrodes 104 arranged in a matrix have an equipotential by connecting the ground electrodes 104 to each other by the ground wiring 128.

The liquid crystal layer 106 includes a liquid crystal material having dielectric anisotropy. For example, a nematic liquid crystal or a cholesteric liquid crystal containing liquid crystal molecules capable of a twist alignment can be used as the liquid crystal material of the liquid crystal layer 106. The liquid crystal layer 106 preferably includes a chiral agent to stabilize the twist alignment of the liquid crystal molecules. The dielectric constant in the liquid crystal layer 106 changes depending on the alignment state of the liquid crystal molecules. In the intelligent reflecting surface 10, the change in the dielectric constant of the liquid crystal layer 106 is used to control a phase of the reflected radio wave.

In the case that the liquid crystal molecules have positive dielectric anisotropy, the dielectric constant is greater when a voltage is applied than when no voltage is applied. In the case that the liquid crystal molecules have negative dielectric anisotropy, the dielectric constant is smaller when a voltage is applied than when no voltage is applied. The liquid crystal layer 106 formed of the liquid crystal having dielectric anisotropy can also be considered as a variable dielectric layer. The reflecting antenna cell 100 can control the phase of the radio wave scattered by the ground electrode 104 to be delayed (or not delayed) by using the dielectric anisotropy of the liquid crystal layer 106.

The frequency band to which the intelligent reflecting surface 10 is applicable are the very high frequency (VHF) band, the ultra-high frequency (UHF) band, the super high frequency (SHF) band, the tremendously high frequency (THF) band, and the extra high frequency (EHF) band. As described above, the alignment of the liquid crystal molecules in the liquid crystal layer 106 changes depending on the voltage applied to the patch electrode 102. However, the alignment of the liquid crystal molecules does not follow the frequency of the radio wave incident on the ground electrode 104. Due to such characteristics of the liquid crystal molecules, it is possible to change the dielectric constant of the liquid crystal layer 106 by the patch electrode 102 while scattering the radio wave at the ground electrode 104 and control the phase of the scattered radio wave.

Glass, quartz, or resin can be used for each of the first substrate 152 and the second substrate 154. Each layer over the first substrate 152 and the second substrate 154 is formed using the following materials. The semiconductor layer 121 is formed using a silicon semiconductor such as amorphous silicon or polycrystalline silicon, or an oxide semiconductor such as indium gallium zinc oxide, indium gallium aluminum oxide, indium gallium oxide, zinc oxide, or gallium oxide. For example, the gate insulating layer 122 and the interlayer insulating layer 124 are formed using a silicon oxide film, or a laminated structure of a silicon oxide film and a silicon nitride film. For example, the selection signal line 126 and the gate electrode 123 are formed using molybdenum (Mo), tungsten (W), or an alloy thereof. The data signal line 127 is formed using a metal material such as titanium (Ti), aluminum (Al), or molybdenum (Mo). For example, the data signal line 127 is formed of a titanium (Ti)/aluminum (Al)/titanium (Ti) laminated structure or a molybdenum (Mo)/aluminum (Al)/molybdenum (Mo) laminated structure. The planarization layer 125 is formed using a resin material such as acrylic or polyimide. The patch electrode 102 and the ground electrode 104 are formed using a metal film such as aluminum (Al) or copper (Cu), or a transparent conductive film such as indium tin oxide (ITO).

### 2. Control of Reflecting Direction of Radio Wave by Reflecting Antenna Cell 100

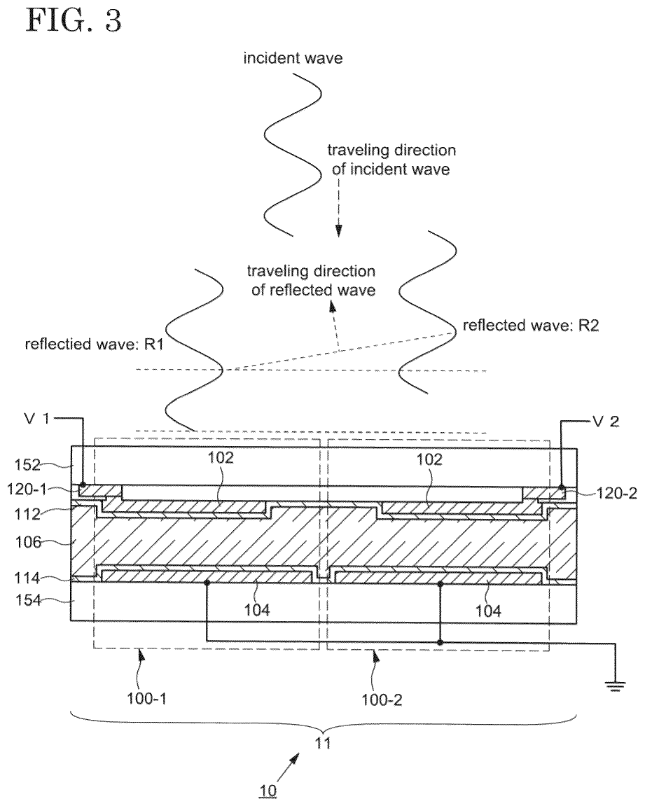

FIG. 3 is a schematic diagram showing a direction in which the radio wave is reflected by the reflecting antenna cell 100 of the intelligent reflecting surface 10 according to an embodiment of the present invention.

FIG. 3 shows two adjacent reflecting antenna cells 100 (a first reflecting antenna cell 100-1 and a second reflecting antenna cell 100-2). The radio wave is incident on the intelligent reflecting surface 10 in parallel with the normal direction of the surface of the first substrate 152 (see “traveling direction of incident wave” in FIG. 3). A first voltage V1 is applied to the patch electrode 102 of the first reflecting antenna cell 100-1 from a first data signal line 127-1 (not shown in FIG. 3), and a second voltage V2 different from the first voltage V1 is applied to the patch electrode 102 of the second reflecting antenna cell 100-2 from a second data signal line 127-2 (not shown in FIG. 3). In addition, the ground electrode 104 of the first reflecting antenna cell 100-1 and the ground electrode 104 of the second reflecting antenna cell 100-2 are at the same potential, and the same voltage (for example, GND) is applied to them.

When the incident waves having the same phase are incident on the first reflecting antenna cell 100-1 and the second reflecting antenna cell 100-2, scattered waves with different phases are generated in the first reflecting antenna cell 100-1 and the second reflecting antenna cell 100-2 by applying the different voltages (V1≠V2) to the first reflecting antenna cell 100-1 and the second reflecting antenna cell 100-2. For example, as shown in FIG. 3, the phase of the scattered wave R2 scattered by the second reflecting antenna cell 100-2 leads the phase of the scattered wave R1 scattered by the first reflecting antenna cell 100-1. In this case, the radio wave reflected by the reflecting antenna region 11 travels in a direction different from the normal direction of the surface of the first substrate 152 (see “traveling direction of reflected wave” in FIG. 3). Although two adjacent reflecting antenna cells 100 are shown in FIG. 3, the reflecting direction of the radio wave can be controlled to any direction by independently controlling the plurality of reflecting antenna cells 100 arranged in a matrix.

### 3. Configuration of Liquid Crystal Layer 106

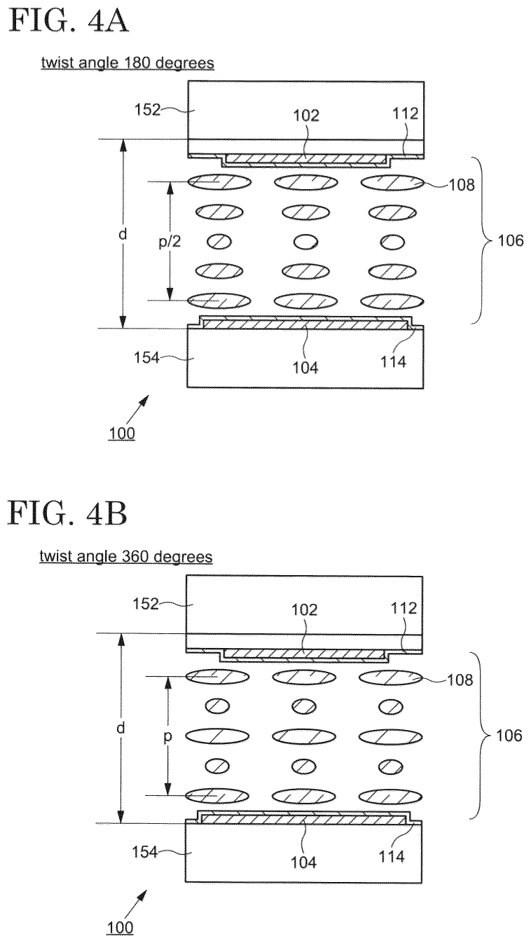

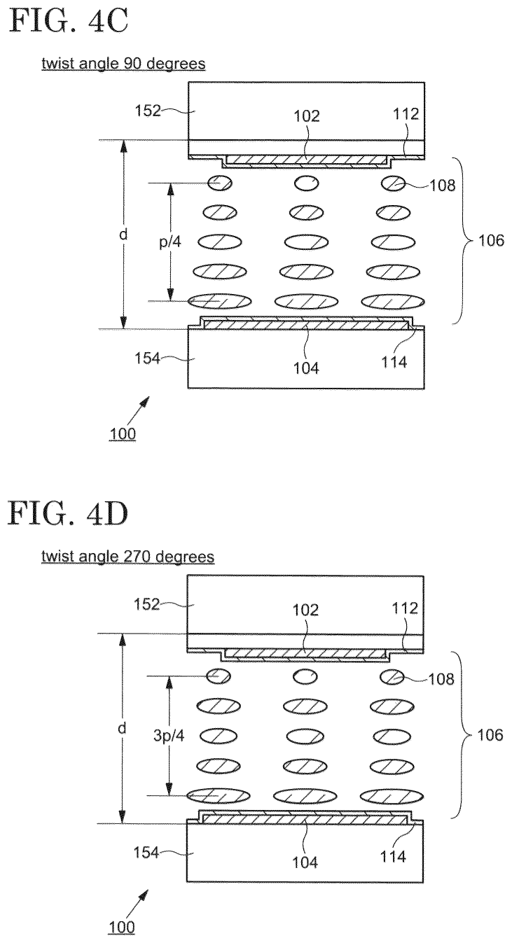

FIGS. 4A to 4D are schematic cross-sectional views showing a configuration of the liquid crystal layer 106 in the reflecting antenna cell 100 of the intelligent reflecting surface 10 according to an embodiment of the present invention.

FIGS. 4A to 4D are schematic diagrams showing liquid crystal molecules 108 in a twist alignment in the liquid crystal layer 106. In FIGS. 4A and 4B, since alignment treatments in the same direction are performed on the first alignment film 112 and the second alignment film 114, the first alignment film 112 and the second alignment film 114 have an easy axis of alignment in the same direction. The twist alignment of the liquid crystal molecules 108 in the liquid crystal layer 106 shown in FIG. 4A and the liquid crystal molecules 108 in the liquid crystal layer 106 shown in FIG. 4B have different twist angles. The liquid crystal molecules 108 in the liquid crystal layer 106 shown in FIG. 4A are aligned with a twist angle of 180 degrees, and the liquid crystal molecules 108 in the liquid crystal layer 106 shown in FIG. 4B are aligned with a twist angle of 360 degrees. In FIGS. 4C and 4D, since alignment treatments in a direction perpendicular to each other are performed on the first alignment film 112 and the second alignment film 114, the first alignment film 112 and the second alignment film 114 have an easy axis of alignment in the direction perpendicular to each other. The twist alignment of the liquid crystal molecules 108 in the liquid crystal layer 106 shown in FIG. 4C and the liquid crystal molecules 108 in the liquid crystal layer 106 shown in FIG. 4D have different twist angles. The liquid crystal molecules 108 in the liquid crystal layer 106 shown in FIG. 4C are aligned at a twist angle of 90 degrees, and the liquid crystal molecules 108 in the liquid crystal layer 106 shown in FIG. 4D are aligned at a twist angle of 270 degrees.

Although the details are described later, the twist angle of the twist alignment is greater than or equal to 90 degrees and less than or equal to 360 degrees, preferably greater than or equal to 180 degrees and less than or equal to 360 degrees, and more preferably greater than or equal to 270 degrees and less than or equal to 360 degrees. When the twist angle is less than 90 degrees, the elastic distortion of the twist alignment of the liquid crystal molecules 108 is not large enough, so that it becomes difficult to increase the response speed of the liquid crystal. When the twist angle is greater than 360 degrees, the alignment may not return to its original state when the voltage applied to the patch electrode 102 is turned off. Therefore, the twist angle of the twist alignment is preferably in the above range.

Each of FIGS. 4A to FIG. 4D shows a distance d between the first substrate 152 and the second substrate 154 (hereinafter, may be referred to as an inter-substrate distance d) and a chiral pitch p of the liquid crystal of the liquid crystal layer 106. The distance d can be controlled by the gap member contained in the liquid crystal layer 106. The distance d is greater than or equal to 10 μm, and preferably greater than or equal to 30 μm. The chiral pitch p can be controlled by the chiral agent contained in the liquid crystal layer 106. The twist angle of the twist alignment is controlled not only by the directions of easy axes of alignment of the first alignment film 112 and the second alignment film 114 but also by the distance d and the chiral pitch p. Specifically, the distance d and the chiral pitch p satisfy the relational equation d≤p<4d/3 or the relational equation d<p<2d. In order to increase the response speed of the liquid crystal, it is preferable to reduce the chiral pitch p and increase the elastic distortion of the twist of the liquid crystal molecules 108. However, when the chiral pitch p is smaller than the distance d, it is possible that a so-called alignment defect occurs in which the liquid crystal molecules are in the splay alignment when the voltage applied to the patch electrode 102 is turned off. Therefore, it is preferable that the distance d and the chiral pitch p satisfy the above-described relational equation. This makes it possible to stabilize the twist angle.

In addition, an alignment defect called a disclination may occur due to discontinuity in the alignment of the liquid crystal molecules 108 in the liquid crystal layer 106. In order to prevent such an alignment defect, it is effective to perform an alignment treatment on each of the first alignment film 112 and the second alignment film 114 so that the liquid crystal molecules 108 have a pretilt angle. However, the alignment defect in the intelligent reflecting surface 10 hardly affects the characteristics of the reflected wave. Therefore, unlike a display device such as an LCD, the intelligent reflecting surface 10 does not require a large pretilt angle, and the pretilt angle may be 0 degrees, for example.

### 4. Correlation Between Twist Angle and Response Time

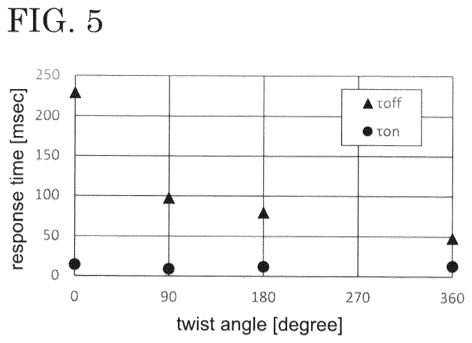

FIG. 5 is a graph showing a correlation between a twist angle of the liquid crystal in the liquid crystal layer 106 and a response time in the intelligent reflecting surface 10 according to an embodiment of the present invention.

The graph shown in FIG. 5 is the result of calculating the response time against the twist angle using a simulator (conditions: liquid crystal (E7), inter-substrate distance (5 μm), applied voltage to patch electrode (5 V)). The horizontal axis of the graph shows the twist angle, and the vertical axis of the graph shows the response time. In addition, since a simulator for LCD was used, the inter-substrate distance could not be set to greater than or equal to 10 μm. However, even if the inter-substrate distance is greater than or equal to 10 μm, it is obvious that the trend of the response time against the twist angle does not change, although the absolute value of the response time changes.

As shown in FIG. 5, the response time (τₒₙ) when a voltage is applied to the patch electrode is small without depending on the twist angle. On the other hand, the response time (τ_{off}) when the voltage applied to the patch electrode is turned off depends on the twist angle. At twist angles in the range greater than or equal to 0 degrees and less than 90 degrees, the response time (τ_{off}) decreases as the twist angle increases, but the change in response time is large. In contrast, at twist angles in the range greater than or equal to 90 degrees and less than or equal to 360 degrees, the change in response time (τ_{off}) against the twist angle is small. Further, twist angles in the range greater than or equal to 90 degrees and less than or equal to 360 degrees have a smaller response time than twist angles in the range greater than or equal to 0 degrees and less than 90 degrees.

As described above, in the intelligent reflecting surface 10, the distance d between the substrates and the chiral pitch p of the liquid crystal in the liquid crystal layer 106 satisfy the predetermined relational equation, and the twist angle is stably controlled, thereby improving the response time and enabling the response speed of the liquid crystal to be increased.

Each embodiment described as embodiments of the present invention can be combined as appropriate as long as they do not contradict each other. Based on each embodiment, any addition, deletion or design change of configuration components, or any addition, omission or change of conditions of the process, made by a person skilled in the art as appropriate, is also included in the scope of the invention, as long as it has the gist of the invention.

It is understood that other advantageous effects different from the advantageous effects resulting from the mode of each embodiment disclosed above, but which are obvious from the description of the present specification or which can be easily foreseen by a person skilled in the art, are naturally brought about by the present invention.

What is claimed is:

1. An intelligent reflecting surface, comprising:
a first substrate;
a plurality of patch electrodes on the first substrate;
a first alignment film covering the plurality of patch electrodes;
a second substrate;
a plurality of ground electrodes on the second substrate;
a second alignment film covering the plurality of ground electrodes, and
a liquid crystal layer including liquid crystal molecules with a twist alignment between the first alignment film and the second alignment film,
wherein a distance (d) between the first substrate and the second substrate is greater than or equal to 10 μm, and
wherein a chiral pitch (p) of the liquid crystal layer and the distance (d) satisfy a relational equation d≤p<4d/3.

2. The intelligent reflecting surface according to claim 1, wherein the first alignment film and the second alignment film have an easy axis of alignment in a same direction.

3. The intelligent reflecting surface according to claim 1,
wherein the first alignment film has an easy axis of alignment in a first direction, and
wherein the second alignment film has an easy axis of alignment in a second direction orthogonal to the first direction.

4. The intelligent reflecting surface according to claim 1, wherein a twist angle of the twist alignment is greater than or equal to 90 degrees and less than or equal to 360 degrees.

5. The intelligent reflecting surface according to claim 1, wherein a twist angle of the twist alignment is greater than or equal to 180 degrees and less than or equal to 360 degrees.

6. The intelligent reflecting surface according to claim 1, wherein a twist angle of the twist alignment is greater than or equal to 270 degrees and less than or equal to 360 degrees.

7. The intelligent reflecting surface according to claim 1, wherein the distance (d) is greater than or equal to 30 μm.

8. An intelligent reflecting surface, comprising:
a first substrate;
a plurality of patch electrodes on the first substrate;
a first alignment film covering the plurality of patch electrodes;
a second substrate;
a plurality of ground electrodes on the second substrate;
a second alignment film covering the plurality of ground electrodes, and
a liquid crystal layer between the first alignment film and the second alignment film,
wherein the liquid crystal layer includes liquid crystal molecules with a twist alignment,
wherein a distance (d) between the first substrate and the second substrate is greater than or equal to 10 μm, and
wherein a chiral pitch (p) of the liquid crystal layer and the distance (d) satisfy a relational equation d<p<2d.

9. The intelligent reflecting surface according to claim 8, wherein the first alignment film and the second alignment film have an easy axis of alignment in a same direction.

10. The intelligent reflecting surface according to claim 8,
wherein the first alignment film has an easy axis of alignment in a first direction, and
wherein the second alignment film has an easy axis of alignment in a second direction orthogonal to the first direction.

11. The intelligent reflecting surface according to claim 8, wherein a twist angle of the twist alignment is greater than or equal to 90 degrees and less than or equal to 360 degrees.

12. The intelligent reflecting surface according to claim 8, wherein a twist angle of the twist alignment is greater than or equal to 180 degrees and less than or equal to 360 degrees.

13. The intelligent reflecting surface according to claim 8, wherein a twist angle of the twist alignment is greater than or equal to 270 degrees and less than or equal to 360 degrees.

14. The intelligent reflecting surface according to claim 8, wherein the distance (d) is greater than or equal to 30 μm.
